(19) United States
(12) Patent Application Publication
(10) Pub. No.: US 2002/0152816 A1
(43) Pub. Date: Oct. 24, 2002

(54) Apparatus for filling gauge and sensor protectors with pressure transmitting fluid, diaphragm housing used therefor, and method using such apparatus

(76) Inventor: Chul-Won Kim, Seoul (KR)

Correspondence Address: Daniel P. Burke, Esq., Galgano & Burke, Suite 135, 300 Rabro Drive, Hauppauge, NY, 11788, US

(21) Appl. No.: 10/087,912

(22) Filed: Mar. 4, 2002

(30) Foreign Application Priority Data
Apr. 20, 2001 (KR) 2001-21538

(51) Int. Cl. G01L 7/08

(52) U.S. Cl. 73/715

(57) ABSTRACT

Disclosed herein is an apparatus for filling gauge and sensor protectors with pressure transmitting fluid, diaphragm housing used therefor and method using such an apparatus. The apparatus includes tubing. A connector is connected to the inner end of the first side of the tubing. A syringe is filled with filling fluid and connected to the outer end of a first branch of the second side of the tubing. A vacuum pump is connected to the outer end of the second branch of the second side of the tubing. A fluid trap container is situated at a position of the tubing between both ends of the second branch of the second side of the tubing. First, second, third and fourth solenoid valves are disposed on the first branch of the second side of the tubing at a position between both ends of the first branch, on a drain tube connected to a portion of the second branch of the second side of the tubing between the vacuum pump and the fluid trap container, on the second branch of the second side of the tubing at a position inside of the fluid trap container, and on the first side of the tubing at a position between both ends of the first side, respectively.

### BACKGROUND OF THE INVENTION

1. Field of the Invention

The present invention relates generally to an apparatus for filling gauge and sensor protectors with pressure transmitting fluid, diaphragm housing used therefor and method using such an apparatus, and particularly to an apparatus for filling gauge and sensor protectors with pressure transmitting fluid and method using such an apparatus, which is capable of minimizing the space that pressure transmitting fluid does not fill and accurately measuring the pressure of a conveying conduit or tank, in such a way that after a diaphragm housing, pressure gauge and sensor and tubing are assembled together, air contained in the upper chamber of the diaphragm housing, the pressure gauge and sensor and the tubing is discharged by a vacuum pump and the interior spaces of the upper chamber of the diaphragm housing, and the pressure gauge and sensor and the tubing are filled with pressure transmitting fluid.

2. Description of the Prior Art

In general, pressure gauges and pressure sensors are utilized in various fields of industry. Particularly, such pressure gauges and pressure sensors are indispensably used in a semiconductor manufacture process and a chemical product manufacturing process so as to measure or detect the pressure of liquid or gas contained in a conveying conduit.

The pressure gauges and pressure sensors are provided with gauge protectors to be prevented from coming into contact with corrosive fluid, that is, to be separated from corrosive fluid.

Each of the gauge protectors generally includes a housing that has diaphragm or bellows type separating means. One side of the diaphragm housing is connected to an inflow conduit through a nipple or fitting, while the other side of the diaphragm housing is connected to pressure gauge and sensor.

U.S. Pat. No. 5,652,391 discloses a diaphragm housing on one side of which there is formed an inlet to which a pipe is connected.

The interior of the diaphragm housing is divided into two chambers by a diaphragm. A lower chamber of the two chambers is extended from the inlet to the diaphragm, while a upper chamber is extended from the diaphragm to a portion connected to the pressure gauge or sensor.

In general, pressure transmitting fluid, such as water, silicon oil or alcohol, fills the upper chamber, and transmits pressure transmitted from the lower chamber through the diaphragm to the pressure gauge or sensor.

Process fluid filling piping or a fluid apparatus passes through the inlet and pushes the lower end of the diaphragm, so the diaphragm is moved toward the pressure gauge and pressurizes the pressure transmitting fluid, thereby allowing pressure to be detected by the pressure gauge or sensor.

A diaphragm type gauge protector having such a structure is used to protect a pressure gauge or sensor from being damaged by corrosive chemicals and prevent the chemicals from being polluted with pollutants from the pressure gauge or sensor.

In this case, the pressure gauge or sensor is generally used while being connected to the upper chamber of the diaphragm housing. As occasions demand, the pressure gauge or sensor may be used in a state in which one end of a pressure transmission tube or conduit, having sufficient thickness and strength to prevent the inner diameter of the pressure transmission tube from varying, is connected to the upper chamber, and the other end of the tube or conduit is extended to a position convenient to install the pressure gauge or sensor and connected to the pressure gauge or sensor through a socket, nipple, fitting or the like.

The pressure of a conduit or tank can be correctly measured only if the upper chamber is filled with incompressible pressure transmitting fluid while or after being connected to the pressure gauge or sensor. Up to now, while the upper chamber is connected to the pressure gauge or sensor, the interior spaces of the upper chamber and the pressure gauge are filled with the fluid using a syringe or the like. Additionally, after the upper chamber is connected to the pressure gauge or sensor, those interior spaces are filled with the fluid using a separate filling apparatus.

However, the fluid filling process is complicated and difficult. Particularly, it is almost impossible to completely fill the interior of the pressure gauge or sensor.

In particular, when the pressure gauge or sensor is situated at a position that is spaced far apart from the gauge protector using the pressure transmission tube, it is more difficult to fill the tube with the pressure transmitting fluid. For this reason, use of the pressure transmission tube is restricted.

It may be considered that process fluid, such as chemicals, is brought to a position near the pressure gauge and sensor. However, it is dangerous to bring toxic chemicals to a position where electric devices are installed.

In this case, if a gauge and sensor protector (that is, a diaphragm housing) is situated near a conveying conduit or tank and tubing is extended from the gauge and sensor protector to the pressure gauge or sensor, the interior spaces of the upper chamber of the diaphragm housing, the tubing and the pressure gauge and sensor are filled with harmless pressure transmitting fluid, thereby preventing a safety problem from occurring.

However, there occurs a problem in which it is difficult to fill the tubing of a relatively small diameter with the pressure transmitting fluid.

When the interior spaces of the upper chamber of the diaphragm housing and the pressure gauge and sensor are not completely filled with the pressure transmitting fluid, air filling the space, which the pressure transmitting fluid does not fill, can be compressed, thereby preventing the pressure gauge and sensor from indicating accurate pressures.

Additionally, with the lapse of time, the pressure transmitting fluid leaks and is reduced, since the upper chamber of the diaphragm housing is filled with the pressure transmitting fluid and the diaphragm housing, the pressure gauge and sensor, the tubing and fittings are assembled together in a screw engagement manner. However, there is no provision for easily measuring the amount of the pressure transmitting fluid and supplementing the pressure transmitting fluid.

### SUMMARY OF THE INVENTION

Accordingly, the present invention has been made keeping in mind the above problems occurring in the prior art, and an object of the present invention is to provide an apparatus for filling gauge and sensor protectors with pressure transmitting fluid and method using such an apparatus, which is capable of minimizing the space that pressure transmitting fluid does not fill and accurately measuring the pressure of a conveying conduit or tank, in such a way that after a diaphragm housing, pressure gauge and sensor and tubing are assembled together, air contained in the upper chamber of the diaphragm housing, the pressure gauge and sensor and the tubing is discharged by a vacuum pump and the interior spaces of the upper chamber of the diaphragm housing, and the pressure gauge and sensor and the tubing are filled with pressure transmitting fluid.

Another object of the present invention is to provide an apparatus for filling gauge and sensor protectors with pressure transmitting fluid and method using such an apparatus, which is capable of easily supplementing pressure transmitting fluid to cope with the leakage of the fluid after the lapse of time and, accordingly, maintaining the reliability of the pressure gauge and sensor.

In order to accomplish the above object, the present invention provides an apparatus for filling gauge and sensor protectors with pressure transmitting fluid, comprising: tubing having a small inner diameter, sufficient thickness and strength to prevent the tubing from being affected by pressure, and a predetermined length; a connector connected to the inner end of the first side of the tubing; a syringe filled with filling fluid and connected to the outer end of a first branch of the second side of the tubing; a vacuum pump connected to the outer end of the second branch of the second side of the tubing; a fluid trap container situated at a position of the tubing between both ends of the second branch of the second side of the tubing; and first, second, third and fourth solenoid valves disposed on the first branch of the second side of the tubing at a position between both ends of the first branch, on a drain tube connected to a portion of the second branch of the second side of the tubing between the vacuum pump and the fluid trap container, on the second branch of the second side of the tubing at a position inside of the fluid trap container, and on the first side of the tubing at a position between both ends of the first side, respectively.

In addition, the present invention provides a method for filling pressure gauges and sensors with pressure transmitting fluid, comprising the steps of: vacuuming interior spaces communicating with the upper chamber of a diaphragm housing, which includes the interior of a pressure gauge; filling the interior spaces with the pressure transmitting fluid by allowing the vacuous interior spaces to communicate with a syringe filled with the pressure transmitting fluid by control means; upwardly curving a diaphragm of the diaphragm housing downwardly curved in the vacuuming step by pressurizing the pressure transmitting fluid and filling the upper chamber with the pressure transmitting fluid by means of the rotation of a piston of the syringe; and minutely adjusting the pressure of the pressure transmitting fluid by inversely rotating the piston of the syringe so as to allow the pressure gauge to indicate zero.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram showing a pressure gauge and sensor arrangement connected to a conveying conduit via a diaphragm housing;

FIG. 2 is a schematic diagram showing an apparatus for filling gauge and sensor protectors with pressure transmitting fluid in accordance with a first embodiment of the present invention;

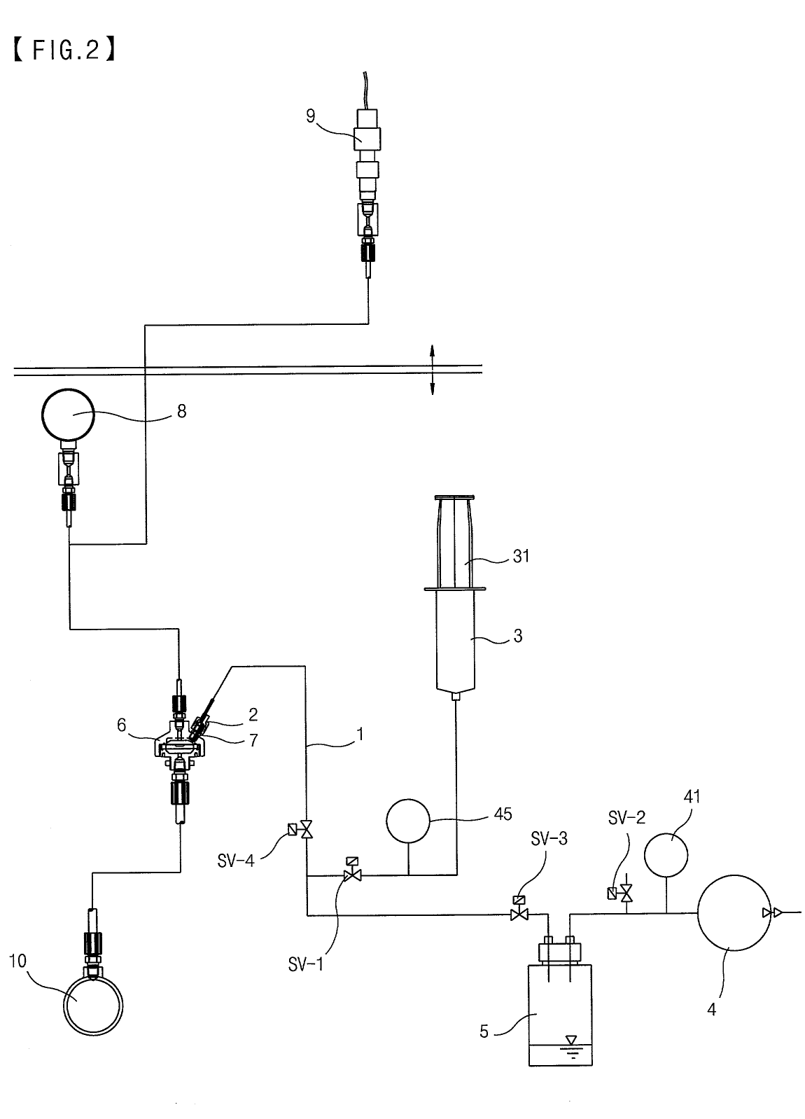

FIG. 3 is a partially sectional view showing a connector engaged with a nipple;

FIG. 4 is a partially sectional view showing a cap engaged with the nipple;

FIG. 5 is a cross section showing the engagement of the connector and the nipple in detail;

FIG. 6 is a cross section showing the engagement of the cap and the nipple in detail; and

FIG. 7 is a schematic diagram showing another apparatus for filling gauge and sensor protectors with pressure transmitting fluid in accordance with a second embodiment of the present invention.

### DESCRIPTION OF THE PREFERRED EMBODIMENTS

Reference now should be made to the drawings, in which the same reference numerals are used throughout the different drawings to designate the same or similar components.

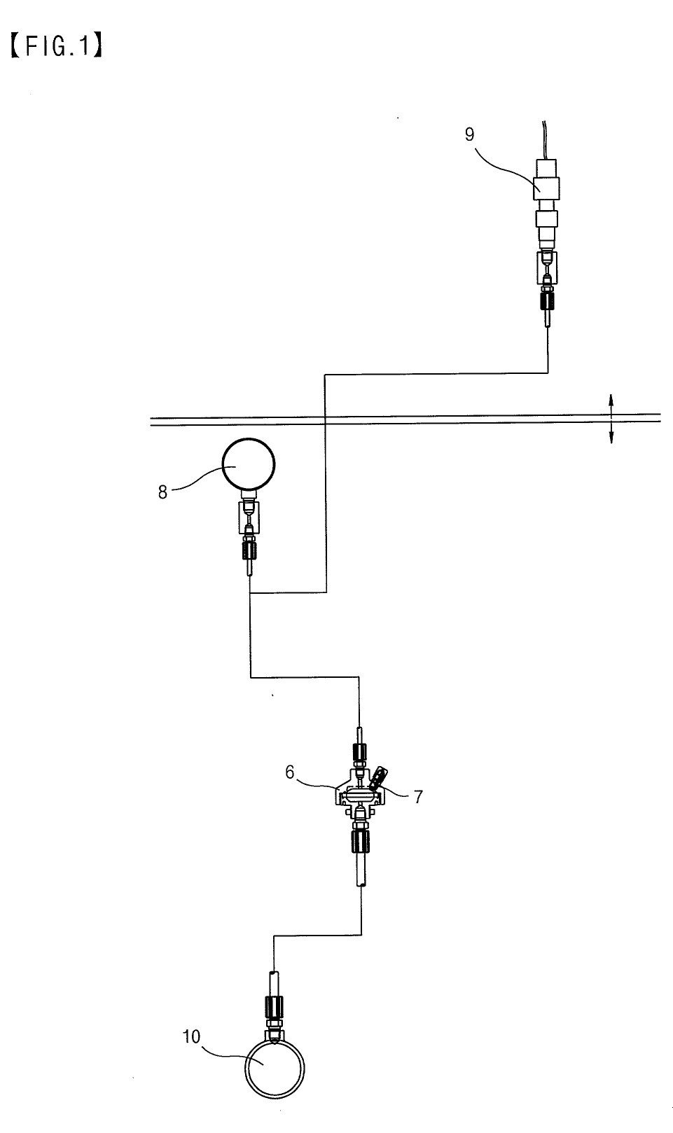

An apparatus for filling gauge and sensor protectors with pressure transmitting fluid, as illustrated in FIG. 1, includes a hose or conduit (tubing 1), which has a small inner diameter, sufficient thickness and strength to prevent the tubing from being affected by pressure, and a predetermined length.

A connector 2 is connected to the inner end of a first side of the tubing 1.

A syringe 3 filled with filling fluid is connected to the outer end of a first branch of a second side of the tubing 1.

A vacuum pump 4 is connected to the outer end of a second branch of the second side of the tubing 1.

A fluid trap container 5 is situated at a position of the tubing 1 between both ends of the second branch of the second side of the tubing 1.

First, second, third and fourth solenoid valves SV-1 to SV-4 are disposed on the first branch of the second side of the tubing 1 at a position between both ends of the first branch, on a drain tube connected to the portion of the second branch of the second side of the tubing 1 between the vacuum pump 4 and the fluid trap container 5, on the second branch of the second side of the tubing 1 at a position inside of the fluid trap container 5, and on the first side of the tubing 1 at a position between both ends of the first side, respectively.

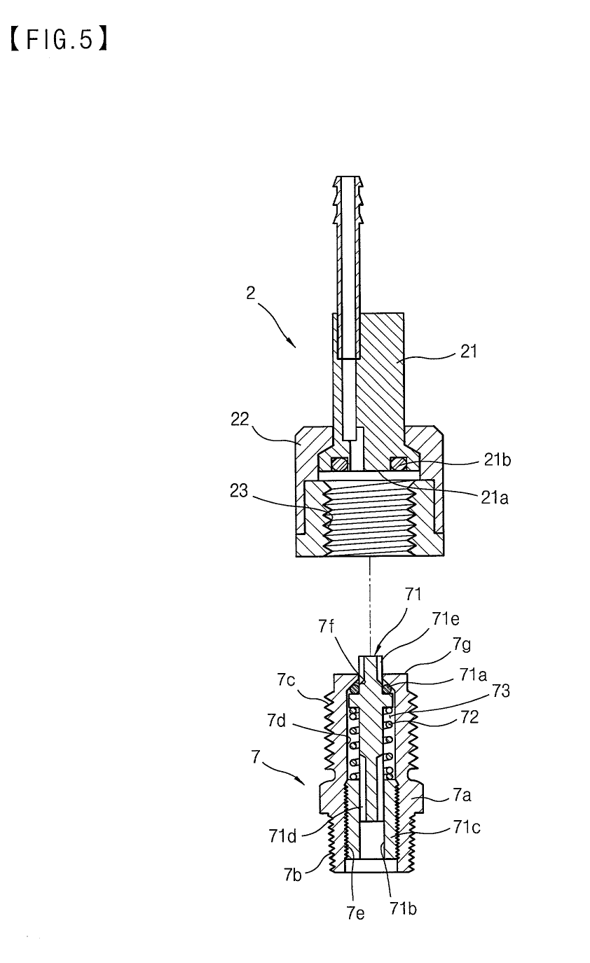

The connector 2, as depicted in FIG. 5, is comprised of a body 21 by which a connecting piece 22 is rotatably held on the side surface of the body 21, in order to be engaged with a nipple 7 that is mounted on one side of the upper portion of a diaphragm housing 6 and has a check valve function. While the connector 2 is fastened on the nipple 7 secured to a side of the diaphragm housing 6, the interior surface 21a of the connector 2 pushes the plunger 71 of the nipple 7 and releases sealing by the O-ring 71a. Instead, the O-ring 21b of the connector 2 is brought into contact with the upper surface 7g of the nipple 7, so new sealing is established in the connection of the connector 2 and the nipple 7.

A general injector may be employed as the syringe 3. A piston 31 is engaged with the internally threaded portion of the inner wall of a syringe body, so the pressure transmitting fluid is gradually discharged from the syringe 3 and the interior spaces of the upper chamber 62, etc. can be precisely filled with the pressure transmitting fluid by the rotation of the piston 31.

The pressure transmitting fluid filling apparatus is fabricated in the form of a kit to be easily carried.

The structure of the diaphragm housing 6 filled with pressure transmitting fluid by the pressure transmitting fluid filling apparatus is described.

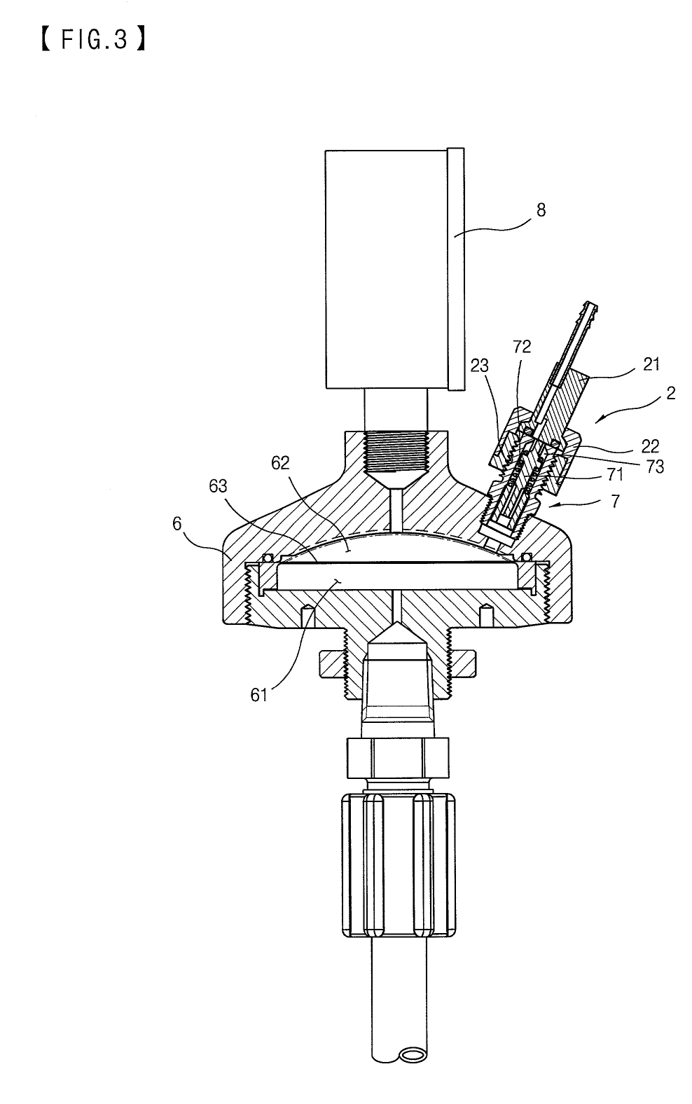

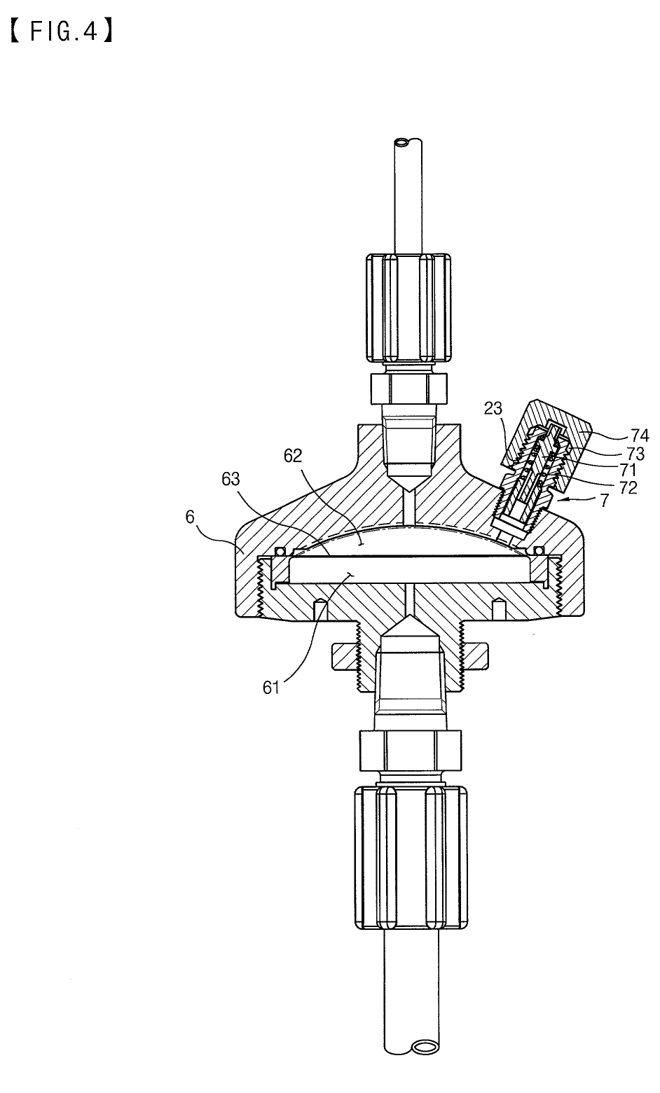

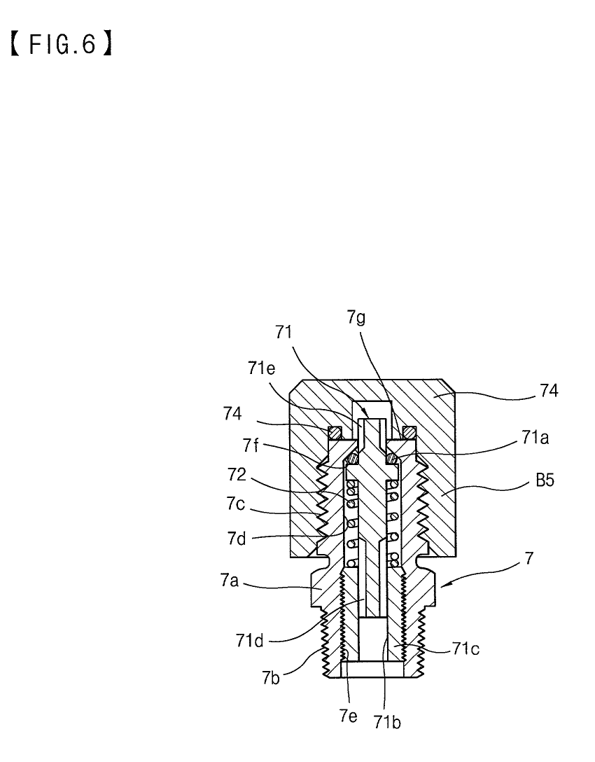

The diaphragm housing 6, as shown in FIGS. 3 to 6, includes a housing. A diaphragm 63 is situated in the center portion of the housing for dividing the interior of the housing 6 into lower and upper chambers 61 and 62. A nipple 7 having a check valve function is mounted on one side of an upper portion of the housing to communicate with the upper chamber 62.

In this case, the nipple includes a cylindrical body 7a that is provided on the upper and lower portions of its side surface with lower and upper externally threaded portions 7b and 7c, in its axial center portion with a first through hole 7d, on the lower portion of the wall defining the first through hole 7d with an internally threaded portion 7e, and on the upper end of the wall defining the first through hole 7d with an internally tapered surface 7f. A plunger 71, which is provided at its upper and lower portions with upper and lower grooves 71d and 71e to communicate with a fluid passage 73, is inserted into the first through hole 7d of the cylindrical body 7a from a position under the first through hole 7d with its top end portion projected from the cylindrical body 7a. An O-ring 71a is disposed between the internally tapered surface 7f and the plunger 71. A spring support 71c having a second through hole 71b is inserted into the lower portion of the wall defining the first through hole 7d while being engaged with the internally threaded portion 7e. A spring 72 is supported by the spring support 71c while being situated around the plunger 71.

The nipple body 7a is engaged on its lower externally threaded portion 7b with a threaded hole formed in the upper portion of the diaphragm housing 6, and disengagably engaged on its upper externally threaded portion with a cap 74. The cap 74 is provided with an O-ring 74a to form sealing.

The nipple 7 is comprised of the body 7a, the spring support 71c, the spring 72, the plunger 71 and the O-ring 71a. The upper space of the interior of the diaphragm housing 6 is sealed from the outside by pushing the plunger 71 by the spring 72 and, thus, bringing the O-ring 71a into contact with the body 7a.

In a normal state, the cap 74 is fastened on the upper portion of the nipple 7, and the O-ring 71a of the cap 74 forms secondary sealing.

A method for filling pressure gauges and sensors with pressure transmitting fluid using the above pressure transmitting fluid filling apparatus is described.

The nipple 7 is mounted on a side of the upper portion of the diaphragm housing 6 so as to selectively open and close the upper chamber 62 of the diaphragm housing 6. The lower chamber 61 of the diaphragm housing 6 is connected to the conduit for conveying fluid, such as chemicals, by tubing. The pressure and sensor 8 and 9 are connected to the upper chamber 62 of the diaphragm housing 6.

As occasions demand, a control panel (not shown) may be connected to the structure using tubing.

The method for filling pressure gauges and sensors with pressure transmitting fluid in accordance with the present invention includes the step of vacuuming interior spaces communicating with the upper chamber 62 of a diaphragm housing 6, which includes an interior of a pressure gauge 8. Thereafter, the interior spaces are filled with the pressure transmitting fluid by allowing the vacuous interior spaces to communicate with a syringe 3 filled with the pressure transmitting fluid by control means. Next, the diaphragm 63 of the diaphragm housing 6 downwardly curved in said vacuuming step is upwardly curved by pressurizing the pressure transmitting fluid and filling the upper chamber 62 with the pressure transmitting fluid by means of the rotation of the piston 31 of the syringe 3. Finally, the pressure of the pressure transmitting fluid is minutely adjusted by inversely rotating the piston 31 of the syringe 31 so as to allow the pressure gauge 8 to indicate zero.

Hereinafter, the pressure transmitting fluid filling method of the present invention is described in detail.

The connector 2 is fastened on the nipple 7 that is mounted on the diaphragm housing 6 and has a check valve function.

While the connector 2 is engaged with the nipple 7, the plunger 71 of the nipple 7 compresses the spring 72 and opens the fluid passage, thereby allowing the interior spaces of the upper chamber 62 of the diaphragm housing 6, the pressure gauge and sensor 8 and 9, and the tubing 1 to communicate with one another.

When the vacuum pump 4 is operated and, subsequently, the solenoid valve SV-2 is excited and closed, the fluid trap container 5 is vacuumed.

In this case, when the solenoid valve SV-3 is excited and opened and the solenoid valve SV-1 communicating with the syringe 3 is opened for a while (for example, about three minutes), the pressure transmitting fluid contained in the syringe 3 reaches the fluid trap container 5 and the portion of the tubing 1 between the syringe 3 and the solenoid valve SV-1 is filled with the pressure transmitting fluid. Thereafter, the solenoid valve SV-1 is closed.

In this state, when the solenoid valve SV-4 situated on the first side of the tubing 1 is opened, air, which is contained in the interior space of the portion of the tubing 1 extended from the upper chamber 62 of the diaphragm housing 6 to the vacuum pump 4 and the interior spaces of the pressure gauge and sensor 8 and 9, is forcibly discharged to thus keep those spaces vacuous (generally, 95% or more vacuum is preferable).

After a certain period of time lapses while a vacuum gauge 41 is observed, the solenoid valve SV-3 is closed (at this time, the vacuum pump 4 is operated or stopped) and, simultaneously, the solenoid valve SV-1 connected to the syringe 3 is opened, thus allowing the pressure transmitting fluid to be drawn from the syringe 3 and filling the interior space of the portion of the tubing 1 extended from the upper chamber 62 of the diaphragm housing 6 to the vacuum pump 4 and the interior spaces of the pressure gauge and sensor 8 and 9 with the pressure transmitting fluid.

At this time, the diaphragm 63 of the diaphragm housing 6 is upwardly curved due to the low pressure of the upper chamber 62 of the diaphragm housing 6. Accordingly, when the pressure transmitting fluid is injected by advancing the piston 31 of the syringe 3 till the pressure gauge 8 indicates 1 to 2 kg/cm², the diaphragm 63 upwardly curved is downwardly curved, thereby filling those spaces with the maximum amount of pressure transmitting fluid.

Thereafter, after the piston 31 of the syringe 3 is gradually moved rearward till the pressure gauge 8 indicates zero, the solenoid valve SV-4 is closed and the connector 2 is removed from the nipple 7. Finally, the cap 74 is secured on the nipple 7, thus completing a pressure transmitting fluid filling process.

In the pressure transmitting fluid filling apparatus, the solenoid valves are constructed to be automatically controllable. The pressure transmitting fluid apparatus is preferably constructed to be portable.

In the case where the pressure transmitting fluid contained in the diaphragm housing 6 mounted on a conveying conduit 10 leaks and the pressure of the pressure transmitting fluid is lowered, the connector 2 is connected to the nipple 7, thereby allowing the pressure to be easily checked and the pressure transmitting fluid to be easily supplemented.

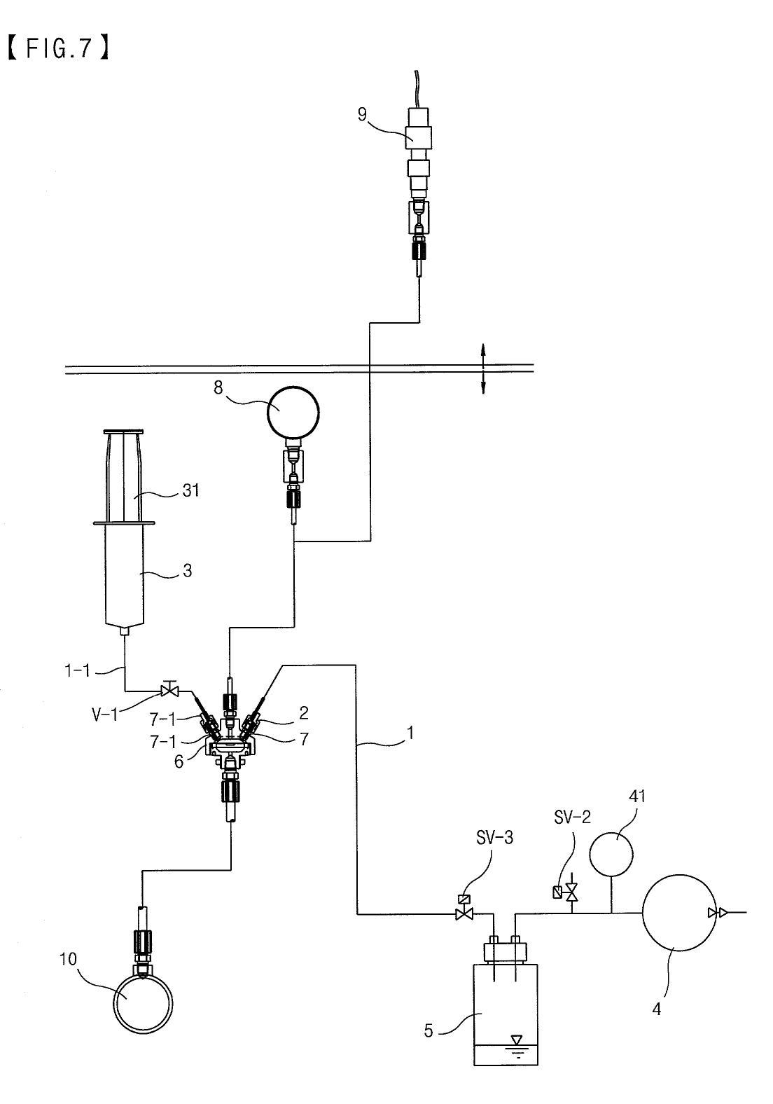

FIG. 7 is a diagram showing an apparatus for filling pressure gauge and sensor protectors with pressure transmitting fluid in accordance with the present invention. This pressure transmitting fluid filling apparatus is particularly useful to the case where the interior of the diaphragm housing 6 is filled with viscous pressure transmitting fluid, such as silicon oil. In this pressure transmitting fluid filling apparatus, another nipple 7-1 separate from the nipple 7 connected to the vacuum pump 4 is mounted on a side of the diaphragm housing 6, another tubing 1-1 connected to the syringe 3 is connected to the nipple 7-1 via another connector 2-1 separate from the connector 2, and a solenoid valve V-l is disposed on the tubing 1-1 at a position near to the connector 2-1.

As described above, when the diaphragm housing 6 is filled with pressure transmitting fluid, such as non- or low-viscosity water or alcohol, the diaphragm housing 6 can be easily filled with the pressure transmitting fluid contained in the syringe 3, by vacuuming the upper chamber 62 of the diaphragm housing 1 and controlling the solenoid valves while a single tubing 1 is connected at its inner end to the connector 2 and the connector 2 is connected to the nipple 7 mounted on the diaphragm housing 6.

However, in the case where highly viscous silicon oil is used as the pressure transmitting fluid, the diaphragm housing 6 may not be filled with the silicon oil when the inner diameter of the tubing 1 is relatively small and the outer end of the tubing 1 is spaced far apart from the diaphragm housing 6.

If a proper amount of the silicon oil fills the diaphragm housing 6, the silicon oil does not leak much, but is difficult to fill the diaphragm housing 6 with.

Accordingly, in this embodiment, when the vacuum pump 4 is operated in a state in which the nipple 7-1 connected to the vacuum pump 4 is mounted on a side of the diaphragm housing 6, the tubing 1-1 connected to the syringe 3 is connected to the nipple 7-1 via the connector 2-1, a solenoid valve V-l is disposed on the tubing 1-1 at a position near to the connector 2-1, the tubing 1 connected to the vacuum pump 4 is connected to the nipple 7 via the connector 2, and the interior spaces communicating with the upper chamber 62 of the diaphragm housing 6 are vacuumed.

If the solenoid valve V-l is closed after being opened for a short period of time (for example, about 3 seconds) while the pressure gauge and sensor protectors are vacuumed, the silicon oil contained in the syringe 3 arrives and is stopped just before the solenoid valve V-l.

When the interior space is vacuumed, the solenoid valve SV-4 is closed and the solenoid valve V-l is opened, thus being capable of filling the interior of the diaphragm housing 6 with the standby silicon oil.

The pressure transmitting fluid filling apparatus of the present invention allows highly viscous pressure transmitting fluid to easily fill the diaphragm housing 6. In this case, this viscous pressure transmitting fluid leaks little, so it can be used for a relatively long period of time and the required amount of maintenance can be reduced.

In the pressure transmitting fluid filling apparatus of the present invention, after a diaphragm housing, pressure gauge and sensor and tubing are assembled together, air contained in the upper chamber of the diaphragm housing, the pressure gauge and sensor and the tubing is discharged by a vacuum pump and the interior spaces of the upper chamber of the diaphragm housing, the pressure gauge and sensor and the tubing are filled with pressure transmitting fluid, thereby minimizing the space that pressure transmitting fluid does not fill. As a result, the pressure of a conveying conduit or tank can be accurately measured and the supplement of pressure transmitting fluid can be easily performed to cope with the leakage of the fluid after the lapse of time, thereby providing many advantages, such as the increased reliability of measured results.

Although the pressure transmitting fluid filling apparatus of the present invention is described in relation to the diaphragm housing, it should be understood that the application of the pressure transmitting fluid is not restricted to the diaphragm housing.

For example, a temperature sensor is connected to a thermowell, and the interior spaces of the temperature sensor, thermowell and tubing can be easily filled with a heat transmitting fluid using the pressure transmitting fluid filling apparatus. That is, various measuring instruments can be easily filled with heat transmitting fluid utilizing the pressure transmitting fluid filling apparatus.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for filling gauge and sensor protectors with pressure transmitting fluid, comprising:
tubing having a small inner diameter, sufficient thickness and strength to prevent the tubing from being affected by pressure, and a predetermined length;
a connector connected to an inner end of a first side of the tubing;
a syringe filled with filling fluid and connected to an outer end of a first branch of a second side of the tubing;
a vacuum pump connected to an outer end of a second branch of the second side of the tubing;
a fluid trap container situated at a position of the tubing 1 between both ends of the second branch of the second side of the tubing; and
first, second, third and fourth solenoid valves disposed on the first branch of the second side of the tubing at a position between both ends of the first branch, on a drain tube connected to a portion of the second branch of the second side of the tubing between the vacuum pump and the fluid trap container, on the second branch of the second side of the tubing at a position inside of the fluid trap container, and on a first side of the tubing at a position between both ends of the first side, respectively.

2. The apparatus according to claim 1, wherein said connector is comprised of a cap body by which a connector is rotatably held on a side surface of the cap body, in order to be engaged with a nipple that is mounted on one side of an upper portion of a diaphragm housing and has a check valve function.

3. The apparatus according to claim 1 or 2, wherein said apparatus is fabricated in the construction of a kit to be easily carried.

4. The apparatus according to claim 1, wherein another nipple separate from the nipple connected to the vacuum pump is mounted on a side of the diaphragm housing, another tubing connected to the syringe is connected to the nipple via another connector separate from the connector, and a solenoid valve is disposed on the tubing at a position near to the connector.

5. A method for filling pressure gauges and sensors with pressure transmitting fluid, comprising the steps of:
vacuuming interior spaces communicating with an upper chamber of a diaphragm housing, which includes an interior of a pressure gauge;
filling the interior spaces with the pressure transmitting fluid by allowing the vacuous interior spaces to communicate with a syringe filled with the pressure transmitting fluid by control means;
upwardly curving a diaphragm of the diaphragm housing downwardly curved in said vacuuming step by pressurizing the pressure transmitting fluid and filling the upper chamber with the pressure transmitting fluid by means of the rotation of a piston of the syringe; and
minutely adjusting the pressure of the pressure transmitting fluid by inversely rotating the piston of the syringe so as to allow the pressure gauge to indicate zero.

6. A diaphragm housing, comprising:
a housing;
a diaphragm situated in the center portion of the housing for dividing an interior of the housing into lower and upper chambers; and
a nipple having a check valve function, said nipple being mounted on one side of an upper portion of the housing to communicate with the upper chamber.

7. The diaphragm housing according to claim 6, wherein said nipple comprises:
a cylindrical body provided on upper and lower portions of its side surface with lower and upper externally threaded portions, in its axial center portion with a first through hole, on a lower portion of a wall defining the first through hole with an internally threaded portion, and on an upper end of the wall defining the first through hole with an internally tapered surface;
a plunger, which is provided at its upper and lower portions with upper and lower grooves to communicate with a fluid passage, inserted into the first through hole of the cylindrical body from a position under the first through hole with its top end portion projected from the cylindrical body;
an O-ring disposed between the internally tapered surface and the plunger;
a spring support having a second through hole, said spring support being inserted into the lower portion of the wall defining the first through hole while being engaged with the internally threaded portion; and
a spring supported by the spring support while being situated around the plunger.

8. The diaphragm housing according to claim 6, wherein said nipple body is engaged on its lower externally threaded portion with a threaded hole formed in the upper portion of the diaphragm housing, and disengagably engaged on its upper externally threaded portion with a cap, said cap being provided with an O-ring to create sealing.
